(19) United States
(12) Patent Application Publication
(10) Pub. No.: US 2024/0326071 A1
(43) Pub. Date: Oct. 3, 2024

(54) SPRAY NOZZLE

(71) Applicant: VALMET AUTOMATION OY, Espoo (FI)

(72) Inventors: Pasi Moilanen, Julkujärvi (FI); Mikko Laukkala, Pirkkala (FI); Kari Söder, Espoo (FI); Iikka Rytkönen, Tampere (FI); Tero Hämeenaho, Tampere (FI); Matti Lindstedt, Pirkkala (FI); Henri Väänänen, Jyväskylä (FR)

(73) Assignee: VALMET AUTOMATION OY, Espoo (FI)

(21) Appl. No.: 18/618,501

(22) Filed: Mar. 27, 2024

(30) Foreign Application Priority Data
Mar. 27, 2023 (FI) 20235348

(51) Int. Cl. B05B 1/34

(52) U.S. Cl. CPC B05B 1/34

(57) ABSTRACT

A spray nozzle includes a first flow channel providing a flow path between a first inlet and a first outlet, and a second flow channel providing a flow path between a second inlet and a second outlet surrounding the first outlet. The first flow channel is delimited by an inner casing and the second flow channel is delimited by an outer casing. In order to achieve an optimized level of uniformity of moisturizing fluid spray, the first outlet includes a plurality of first outlet openings, wherein the first outlet openings are separated by first slats extending helically at least a part of the distance between the first inlet and the first outlet.

### BACKGROUND OF THE INVENTION

### Field of the Invention

This invention relates to a spray nozzle having a first flow channel and a second flow channel.

### Description of Prior Art

In relation to industrial moisturizing applications based on spraying of a moisturizing fluid, such as applications encountered in paper, board and corrugate manufacturing industries, it is typically desirable to achieve as high level of uniformity of the moisturizing fluid spray as possible. In other words, the size of the individual droplets comprised in the moisturizing fluid spray, as well as the droplet size distribution, should be as small as possible, and these characteristics should ideally be maintainable over a wide range of flow rates of the moisturizing fluid through the spraying unit. These characteristics are particularly important in the paper manufacturing industry, as well as other industries producing cellulose-based products, wherein the properties of the continuous material preform on the production line, such as a paper web, are constantly adjusted by water moisturizing so as to ensure a consistent quality of the end product, as well as the continuity of the manufacturing process. At the same time, any excessive feed of the moisturizing fluid is undesirable, since this will result in suboptimal drying time of the product.

In order to obtain a high level of uniformity of the moisturizing fluid spray, said fluid being typically water, it is known to use different spray nozzle arrangements utilizing pressurized air flow for atomizing the moisturizing fluid. In order to optimize the spray characteristics, increasingly complicated channel configurations and tight dimensional tolerances have been utilized in these known spray nozzles, resulting in complicated multi-component designs. However, the level of uniformity of the moisturizing fluid spray achieved using the known nozzle arrangements is still less than ideal.

### SUMMARY OF THE INVENTION

An object of the present invention is to solve the above-mentioned drawbacks and to provide a spray nozzle enabling improved quality of the moisturizing fluid spray. This object is achieved with a spray nozzle according to independent claim 1.

By providing the spray nozzle with a first flow channel comprising a plurality of first outlet openings separated by helically extending slats, it is possible to obtain a structure allowing for increased level of uniformity of the moisturizing fluid spray.

Preferred embodiments of the invention are disclosed in the dependent claims.

### BRIEF DESCRIPTION OF DRAWINGS

In the following the present invention will be described in closer detail by way of example and with reference to the attached drawings, in which

FIG. 1 illustrates a cross-cut section of a spray nozzle as seen directly from the side,

FIG. 2 illustrates a cross-cut section of the spray nozzle of FIG. 1 as seen diagonally from above,

FIG. 3 illustrates the spray nozzle of FIG. 1 as seen directly from above, and

FIG. 4 illustrates the spray nozzle of FIG. 1 arranged to a beam as seen directly from the side.

### DESCRIPTION OF AT LEAST ONE EMBODIMENT

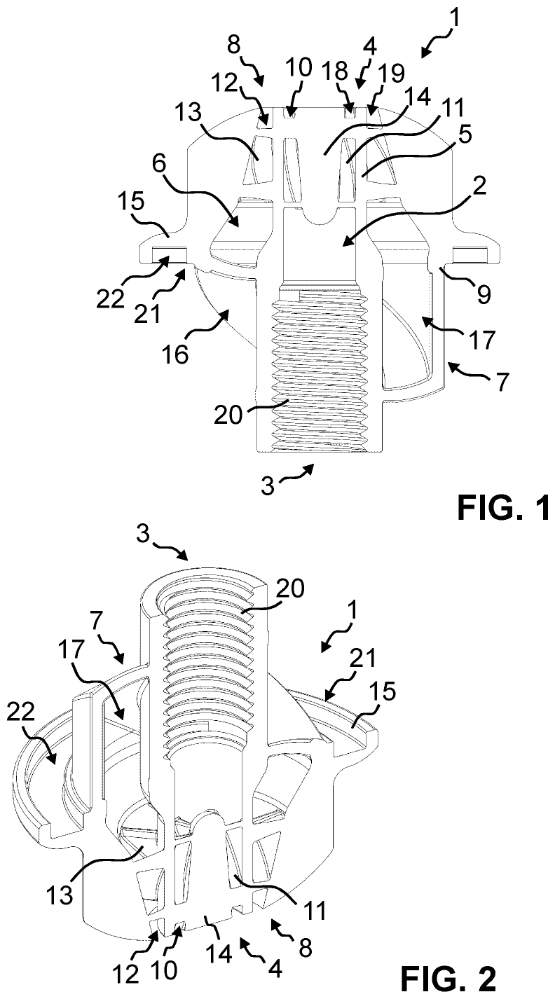

To demonstrate the internal structure according to one embodiment of the spray nozzle 1, FIG. 1 illustrates a cross-cut section of the spray nozzle 1 as seen from the side. The example of FIG. 1 is only meant to illustrate one possible arrangement of the different functional elements and their mutual relation within the spray nozzle, and the dimensions and placement of the illustrated elements may deviate from said example in other embodiments of the spray nozzle 1.

As can be seen in the example of FIG. 1, the spray nozzle 1 comprises a first flow channel 2 providing a flow path between a first inlet 3 and a first outlet 4, and a second flow channel 6 providing a flow path between a second inlet 7 and a second outlet 8. Said first flow channel 2 is delimited by an inner casing 5, and in a typical use setup of the spray nozzle 1 is utilized for conveying a moisturizing fluid, for example water, from the first inlet 3 to the first outlet 4. In this typical use setup, the second flow channel 6 is then utilized for conveying an atomizing fluid, for example pressurized air, from the second inlet 7 to the second outlet 8. The second flow channel 6 is delimited by an outer casing 9, which in the example of FIG. 1 is formed together with the inner casing 5 into a single body having an integral structure. In other words, the inner casing 5, which in said example is surrounded by the outer casing 9, connects seamlessly to the outer casing 9 and is provided to the same nozzle body during the manufacture of the spray nozzle 1.

To better illustrate the remaining structural elements of the spray nozzle 1, FIG. 2 illustrates a cross-cut section of the spray nozzle of FIG. 1 as seen diagonally from above in a rotated orientation. As best seen in FIG. 2, the second outlet 8 is arranged to surround the first outlet 4. More precisely, in the example of FIGS. 1 and 2 the second outlet 8 has an annular shape forming a ring around the first outlet 4, and the inner perimeter of the second outlet 8 is defined by the outer wall of the inner casing 5. Furthermore, in said example the second flow channel 6 surrounds the first flow channel 2 and said outer wall of the inner casing 5 simultaneously defines the inner perimeter of the second flow channel 6. In other words, the outer wall of the inner casing 5 forms one of the surfaces of the second flow channel 6 that during use of the spray nozzle 1 form a contact with a fluid flow, said fluid being preferably the atomizing fluid.

As seen in FIGS. 1 and 2, the outer perimeter of the second flow channel 6 is defined by the outer casing 9. In said example, the outer casing 9 in the proximity of the second outlet 8 is formed such that the second flow channel 6 has a conical outer shape tapering towards the second outlet 8. In other words, the outer perimeter of the second flow channel 6 tapers towards the second outlet 8, and since the inner perimeter of the second flow channel 6 in said example has a constant radius in the proximity of the second outlet 8, said tapering causes the second flow channel 6 to be throttled in the direction of the fluid flow. During use of the spray nozzle 1, the shape as disclosed causes the fluid flow within the second flow channel 6 to be accelerated, providing an output of a high velocity stream of fluid, namely the atomizing fluid. Simultaneously, the conically shaped outer perimeter acts as a directing surface for the pressurized fluid flow within the second flow channel 6, causing the fluid flow exiting the spray nozzle 1 through the second outlet 8 to have a shape of a cone tapering in the direction of the fluid flow.

In the example of FIGS. 1 and 2, also the first outlet 4 has an annular shape, wherein the first outlet 4 forms a ring around a throttle member 14 provided to the first flow channel 2. In other words, the outer surface of the throttle member 14 defines the inner perimeter of the first outlet 4, as well as the inner perimeter of the first flow channel 2 in the proximity of the first outlet 4. Thereby, the outer wall of the throttle member 14 forms one of the surfaces of the first flow channel 2 that during use of the spray nozzle 1 form a contact with a fluid flow, said fluid being preferably the moisturizing fluid. The throttle member 14 in said example extends from the middle of the first outlet 4 to a part of the distance between the first inlet 3 and the first outlet 4 and has a conical shape widening towards the first outlet 4. In the example of FIGS. 1 and 2, the outer perimeter of the first flow channel 2 has a constant radius in the proximity of the first outlet 4, and thereby said widening of the throttle member 14 causes the first flow channel 2 to be throttled in the direction of the fluid flow. During use of the spray nozzle 1, the shape as disclosed causes the fluid flow within the first flow channel 2 to be accelerated, providing an output of a high velocity stream of fluid. In other embodiments of the spray nozzle 1, the throttle member 14 may also extend further from the first outlet 4, and even cover the whole distance between the first inlet 3 and the first outlet 4.

The conically shaped outer wall of the throttle member 14 also acts as a directing surface for the pressurized fluid flow within the first flow channel 2, causing the fluid flow exiting the spray nozzle 1 through the first outlet 4 to have a shape of a cone widening in the direction of the fluid flow. In other words, with the arrangement of the first 2 and the second flow channel 6 as disclosed, two conical flow formations are created during use of the spray nozzle 1, wherein the conical fluid flow exiting the spray nozzle 1 through the first outlet 4 expands in the direction away from the spray nozzle 1 and the fluid flow exiting the spray nozzle 1 through the second outlet 8 tapers in the direction away from the spray nozzle 1. Consequently, the two fluid flows are arranged to intersect in the space in front of the first 4 and the second outlet 8 outside the spray nozzle 1, more specifically on a plane parallel to the plane or planes on which the first 4 and the second outlet 8 are located. With the arrangement as disclosed, the fluid flow passed through the first flow channel 2, namely the flow of the moisturizing fluid, is collided with the fluid flow passed through the second flow channel 6, namely the atomizing fluid, causing the fluid flow from the first flow channel 2 to be atomized into fine fractions or droplets.

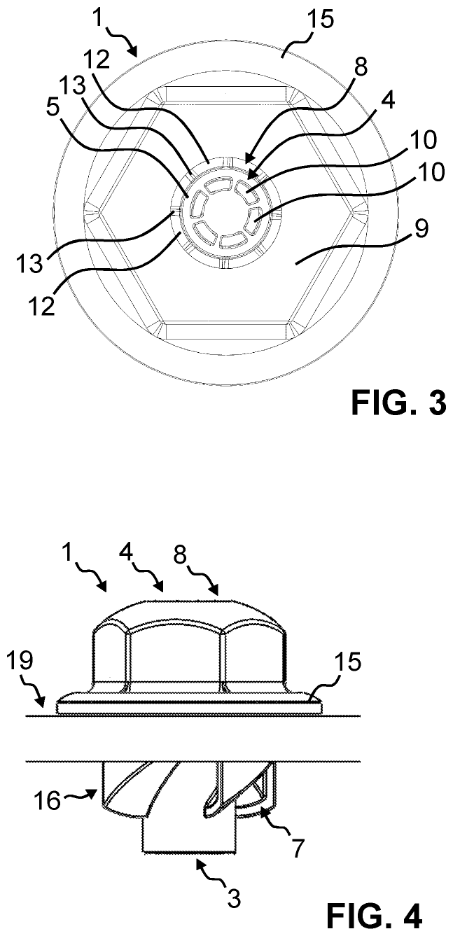

FIG. 3 illustrates the spray nozzle of FIGS. 1 and 2 as seen directly from above. As best seen in this figure, the first outlet 4 comprises a plurality of first outlet openings 10 which are separated by first slats 11 extending helically a part of the distance between the first inlet 3 and the first outlet 4. In other words, the first outlet 4, which in the example of FIGS. 1 to 3 has an annular shape, is arranged such that its circular cross-section is divided by the first slats 11 into 10 several segments, each of the segments forming one of the first outlet openings 10. The first slats 11 extend within the first flow channel 2 said part of the distance between the first inlet 3 and the first outlet 4, dividing it into several helical channel sections leading to the first outlet openings 10. In said example, the first outlet 4 comprises six first outlet openings 10, but the number of the openings 10, as well as the number of the first slats 11, may deviate from said example in other embodiments of the spray nozzle 1. In some embodiments of the spray nozzle 1, the first slats 11 may also extend further between the first inlet 3 and the first outlet 4, and even cover the whole distance between the first inlet 3 and the first outlet 4. However, by arranging the first slats 11 to only extend a precisely defined distance between the first inlet 3 and the first outlet 4, any undesired throttling of the first flow channel 2 by the slats may be avoided or minimized. For example, premature throttling of the channel, meaning reduction of its cross-sectional area, at its middle section may be avoided, and thereby undesired turbulence and loss of pressure of the flow inside the channel.

Similarly to the first outlet 4, the second outlet 8 in the examples of FIGS. 1 to 3 comprises a plurality of second outlet openings 12 separated by second slats 13 extending helically a part of the distance between the second inlet 7 and the second outlet 8. In said example, the second outlet 8 is also arranged into an annular shape such that its circular cross-section is divided by the second slats 13 into several segments, each segment forming one of the second outlet openings 12. The second slats 13 may be placed and dimensioned independently of the first slats 11, such that they may cover a different length of the second flow channel 6 compared to the first slats 11, and they may have a helix angle and wall thickness different from the first slats 11. In some embodiments of the spray nozzle 1, both the first 11 and the second slats 13 may also have a non-constant helix angle and wall thickness across their length, so as to alter the helicity and the cross-sectional area of the channel sections divided by the slats. Similarly to the arrangement of the first slats 11, by arranging the second slats 13 to only extend a precisely defined distance between the second inlet 7 and the second outlet 8, any undesired throttling of the second flow channel 6 by the slats may be avoided or minimized.

Further, the orientation and cross-sectional shape of each slat 11, 13 may be set individually at any point across the length of the slats 11, 13, so as to optimize the fluid flow characteristics within the first 2 and the second flow channel 6 in a given use application. According to one preferred embodiment of the spray nozzle 1, the second slats 13 have the same direction of rotation as the first slats 11, but different helix angle. Preferably, the number of the second outlet openings 12 comprised in the second outlet 8, and thereby the number of the second slats 13, is different from the number of the first outlet openings 10 comprised in the first outlet 4. This has been found to have a favorable influence on the degree of atomization achieved with the spray nozzle 1. In the example of FIGS. 1 to 3, for instance, the second outlet 8 comprises eight second outlet openings 12. In yet other embodiments of the spray nozzle 1, the second slats 13 may also be completely omitted. In some embodiments, the first 11 and the second slats 13 may also have different directions of rotation.

With the arrangement of the first slats 11 as disclosed, the orientation of the fluid flow inside the first flow channel 2, as well as the fluid dynamics after the fluid is passed through the first outlet openings 10, may be influenced. More specifically, the helical form of the first slats 11 causes the fluid passing through the first flow channel 2 to assume a spinning motion component, thereby stabilizing the fluid stream after the fluid passes through the first outlet openings 10. At the point of exiting the spray nozzle 1, the fluid also experiences a degree of mechanical atomization due to the abruptly changing pressure condition, as well as the geometry of the first flow channel 2, the first slats 11 and the first outlet openings 10. Thereby, this preliminary atomization of the fluid may be further enhanced by the design of the first slats 11, and the increased number of the first outlet openings 10 and of the first slats 11 has been found to increase the degree of the mechanical atomization. By forming the first slats 11 to have a progressively increasing cross-sectional area in the direction of the fluid flow, they may also be used for further throttling the first flow channel 2, thereby further increasing the velocity of the fluid flow.

The arrangement of the second slats 13 as disclosed enables similar benefits to be obtained in relation to the fluid passed through the second flow channel 6 as disclosed above in relation to the first slats 11. More specifically, by utilizing the second slats 13, higher stability of the fluid stream exiting the spray nozzle 1 through the second outlet openings 12, as well as the possibility for further throttling the second flow channel 6 are achieved. Said higher stability of the fluid stream, namely the stream of the atomizing fluid, allows for a higher impact force to be conveyed by the fluid stream to the stream of the moisturizing fluid passed through the first outlet openings 10 at the point of intersection of the two conical fluid streams. This, in turn, results in a higher degree of atomization of the moisturizing fluid to be obtained, in other words in a smaller size of the individual fluid droplets and the droplet size distribution. For example, by utilizing the spray nozzle 1 as disclosed, an average droplet size of approximately 0.1 mm may be achieved.

Further, it has been found that the arrangement of the first 2 and the second flow channel 6 as disclosed allows said high degree of atomization of the moisturizing fluid to be maintained over a wide range of flow rates of the moisturizing fluid, without the stability of the fluid flow being lost even at low flow rates of the moisturizing and the atomizing fluid. That is, phenomena causing fluid flow destabilization in conventional spray nozzle arrangements, such as entrance of air to the moisturizing fluid channel through the channel outlet associated with low flow rates of the moisturizing fluid, is minimized. This is due to the reduced cross-sectional area of the separated channel sections of the first flow channel 2 according to the example of FIGS. 1 to 3, attributed to the use of the first slats 11 for separating the plurality of the first outlet openings 10.

In the example of FIGS. 1 to 3, the first 10 and the second outlet openings 12 are arranged within the outer perimeter of the spray nozzle 1. More precisely, the inner casing 5 extends further from the first inlet 3 than the first slats 11, and the outer casing 9 extends further from the second inlet 7 than the second slats 13. Thereby, the first 11 and the second slats 13 in said example do not extend until the outer borders of the inner casing 5 and the outer casing 9 at the first 4 and the second outlet 8, respectively, resulting in a first gap 18 being formed between said outer border of the inner casing 5 and the first slats 11, and a second gap 19 being formed between the outer border of the outer casing 9 and the second slats 13. Depending on the desired behavior of the fluid flow passing through the outlets 4, 8, the first 18 and the second gap 19 may be arranged to have an equal depth, for example, or either one of them may be arranged to extend deeper from the outer perimeter of the spray nozzle 1 than the other. With the embedded structure of the slats 11, 13 as disclosed, cleaning of the first 2 and the second flow channel 6 in the proximity of the first 4 and the second outlet 8 is facilitated, which is beneficial in industrial applications requiring minimized contamination of the product to be moisturized, such as applications encountered in the paper manufacturing industry. Said cleaning is further facilitated by the seamless structure of the spray nozzle 1 as disclosed, wherein any gaps forming between abutting component surfaces, as seen in typical nozzle constructions, are omitted. In the example of FIGS. 1 to 3, the inner casing 5, the outer casing 9 and the throttle member 14 extend until a common plane to form the outer perimeter of the spray nozzle 1 at the outlet side, in other words such that none one of the inner casing 5, the outer casing 9 and the throttle member 14 extends further than the other parts. This arrangement further facilitates the cleaning of the spray nozzle 1, as the number of protruding surfaces is minimized at the outlet side.

FIG. 4 illustrates the spray nozzle of FIGS. 1 to 3 arranged to a beam 19. More specifically, the beam 19 in the example of FIG. 4 is a moisturizer beam used in, for example, paper machine setups wherein the moisturizer beam is positioned in the proximity of a paper web perpendicularly to the direction of movement of the paper web. The illustration of FIG. 4 corresponds to a setup in which the moisturizing is performed from below of the paper web, but in other variations of the moisturizer beam setup, the moisturizer beam 19 may also be placed to, for example, a reversed orientation in which the first 4 and the second outlet 8 are facing downwards. That is, the moisturizer beam 19 as disclosed may be placed to any required orientation without compromising its functionality.

The moisturizer beam 19 as described is typically connected to a pressure source, such as a pressurized air inlet, such that the inner side of the moisturizer beam 19, namely the side at which the first 3 and the second inlet 7 of the spray nozzle 1 are arranged, is at an elevated pressure compared to the outer side. In this arrangement, the pressurized air is channeled to the second flow channel 6 through the second inlet 7 and is thereby used as the atomizing fluid the way disclosed above. The moisturizer beam 19 may comprise numerous spray nozzles 1, such that the elevated pressure is distributed to all said spray nozzles 1 simultaneously. The moisturizer beam 19 may also be arranged to accommodate a delivery system for the moisturizing fluid connecting to the first inlet 3, such as a water pipe. For this purpose, in the example of FIGS. 1 to 4 the first flow channel 2 is provided with a thread 20 in the proximity of the first inlet 3.

In the example of FIGS. 1 to 4, the spray nozzle 1 is provided with a flange 15 extending outwards from the outer casing 9. In said example, the flange 15 and the outer casing 9 are formed into a single body having an integral structure, in other words no additional components are connected to the nozzle body to form the flange 15. As best seen in FIG. 4, the flange 15 is used for connecting the spray nozzle 1 to the beam 19, in this case a moisturizer beam, such that a bottom surface 21 of the flange 15 abuts the top surface of the beam 19. In this arrangement, the body of the spray nozzle 1, namely the inner 5 and the outer casing 9, extend through an opening provided to the beam wall. In order to secure the attachment of the spray nozzle 1, additional connecting elements, such as screws or bolts may be used. Alternatively, the attachment may be secured by interference fitting or by utilizing threads provided to the outer casing 9 and the beam 19. In the example of FIGS. 1 to 4, the flange 15 is also provided with a sealing groove 22 opening to the bottom surface 21.

As best seen in FIGS. 1 and 2, the second flow channel 6 comprises a plurality of helical sections 16. In this example, the second inlet 7 also comprises a plurality of second inlet openings 17 opening tangentially around the inner casing 5 at each of the helical sections 16. In said example, the helical sections 16 extend between a plane defined by the bottom surface 21 of the flange 19 and the second inlet openings 17, and do not intersect with the second slats 13 provided to the second flow channel 6 in the proximity of the second outlet 8. With the arrangement as disclosed, the fluid flow arriving to the second flow channel 6 through the second inlet openings 17 is brought to a cyclonic motion before its arrival to the channel section provided with the helical second slats 13, whereby the second slats 13 then further intensify the cyclonic motion. Thereby, said arrangement differs from a nozzle arrangement in which the flow channel comprises, for example, one or several helical channels or tubes extending uninterrupted from an inlet to an outlet. Namely, with the arrangement according to the example of FIGS. 1 and 2, a maximized cross-sectional area of the second flow channel 6 is achieved while simultaneously achieving the cyclonic motion of the fluid flow. In different embodiments of the spray nozzle 1, the helix angle of the helical sections 16 may be set independently of the helix angle of the second slats 13.

The spray nozzle 1 according to the example of FIGS. 1 to 4 has a structure in which the inner casing 5, the outer casing 9 and the first slats 11 are also formed into a single body having an integral structure. In other words, said elements connect to each other seamlessly and are provided to the same nozzle body during the manufacture of the spray nozzle 1. In different embodiments of the spray nozzle 1, any of the structural elements comprised in the nozzle structure may be similarly formed, such that the spray nozzle 1 in its entity may be formed of a singular, monolithic nozzle body. Alternatively, some of the structural elements may be provided into one nozzle body, while the remaining elements are provided to the structure as separate components.

According to a preferred embodiment of the spray nozzle 1, the spray nozzle 1 is manufactured using an additive manufacturing method. More preferably, the additive manufacturing method used for the manufacture is Metal Binder Jetting, in which the spray nozzle 1 is formed one material layer at a time from a bed of pulverized metal using an appropriate binder material, such as an organic binder liquid. By utilizing additive manufacturing, the spray nozzle structure as disclosed above may be manufactured in its entity during one manufacturing step, allowing for complex internal shapes and high degree of customization to be realized without resorting to multi-component designs utilized in conventional nozzle structures. Thereby, any seams or gaps between the structural element may be omitted, resulting in fewer turbulence-inducing formations inside the flow channels 2, 6 of the spray nozzle 1.

Further, by utilizing additive manufacturing, the spray nozzle 1 according to the example of FIGS. 1 to 4 may be manufactured such that also each side wall of the first flow channel 2 and the second flow channel 6 is formed to a single body having an integral structure. In other words, each side wall of said flow channels is defined by one continuous and seamless structure, as opposed to the conventional nozzle structures in which at least one of the flow channels is typically defined by several adjoined components, so as to enable complex channel structures to be formed. Additionally, by additive manufacturing any component assembly steps and use of sealing parts associated with the manufacture of conventional spray nozzle designs are omitted, resulting in faster and more economical manufacture of the spray nozzle. Also, the integral structure as disclosed allows the spray nozzle 1 to be designed smaller than otherwise possible, by allowing the structural elements of the nozzle to be nested and intertwined in a way that conventionally has not been achievable.

In order to optimize the degree of fluid atomization as a result of the fluid flow from the first flow channel 2 intersecting with the fluid from the second flow channel 6, dimensioning of the first 10 and the second outlet openings 12 is found to be crucial. In the example of FIGS. 1 to 3, the second outlet openings 12 arranged in the annular formation have an opening width of less than 1 mm, and more preferably, said opening width is less than 0.8 mm. Correspondingly, the opening width of the first outlet openings 10 arranged in the annular formation in said example is also less than 1 mm, and more preferably, the opening width of the first outlet openings 10 is less than 0.8 mm. Said opening widths are preferably also highly uniform around the annular perimeter of the outlet openings 10, 12. In this context, the opening width is defined as a width of the first 10 and the second outlet openings 12 in the radial direction of the annular form of the first 4 and the second outlet 8.

Due to the relatively small dimensions and tight dimensional tolerances of the first 10 and the second outlet openings 12 as disclosed, as well as the fine internal structure of the first 2 and the second flow channel 6, Metal Binder Jetting may be used as one preferred method for the manufacturing of the spray nozzle 1. That is, the high dimensional accuracy and low achievable surface roughness characteristic to Metal Binder Jetting are found to be well suited for the manufacture of the spray nozzle 1. Other additive manufacturing methods according to the current state of the art, such as methods based on laser beam scanning, may also be adapted for the manufacture, and further advancement of these methods may be expected to further improve their utility in the future. An additional benefit obtained by utilizing Metal Binder Jetting is the fact that the necessity to use sacrificial structures, such as removable support structures inside the flow channels is avoided. The spray nozzle 1 according to the examples of 1 to 4 may be manufactured of any metal or metal alloy available for the manufacturing methods as disclosed. Preferably, said metal or metal alloy is a corrosion resistant alloy, such as stainless steel or an aluminum alloy.

It is to be understood that the above description and the accompanying figures are only intended to illustrate the present invention. It will be obvious to a person skilled in the art that the invention can be varied and modified without departing from the scope of the invention.

1. A spray nozzle comprising:
a first flow channel providing a flow path between a first inlet and a first outlet, the first flow channel being delimited by an inner casing, and
a second flow channel providing a flow path between a second inlet and a second outlet surrounding the first outlet, the second flow channel being delimited by an outer casing, wherein the first outlet comprises a plurality of first outlet openings, the first outlet openings being separated by first slats extending helically at least a part of the distance between the first inlet and the first outlet,
the second outlet comprises a plurality of second outlet openings, the second outlet openings being separated by second slats extending helically at least a part of the distance between the second inlet and the second outlet, and
the second flow channel comprises a plurality of helical sections for bringing a fluid flow arriving to the second flow channel to a cyclonic motion before its arrival to a channel section provided with the second slats.

2. A spray nozzle according to claim 1, wherein the number of the first outlet openings comprised in the first outlet is different from the number of the second outlet openings comprised in the second outlet.

3. A spray nozzle according to claim 1, wherein the inner casing extends further from the first inlet than the first slats, and
the outer casing extends further from the second inlet than the second slats.

4. A spray nozzle according to claim 1, wherein the inner casing, the outer casing and the first slats are formed into a single body having an integral structure.

5. A spray nozzle according to claim 1, wherein the first and the second outlet have an annular shape, and the first flow channel is provided with a throttle member extending from the middle of the first outlet to at least a part of the distance between the first inlet and the first outlet, the throttle member having a conical shape widening towards the first outlet.

6. A spray nozzle according to claim 5, wherein the second flow channel surrounds the first flow channel and has a conical outer shape tapering towards the second outlet in the proximity of the second outlet.

7. A spray nozzle according to claim 1, wherein each side wall of the first flow channel and the second flow channel is formed to a single body having an integral structure.

8. A spray nozzle according to claim 1, wherein the spray nozzle is provided with a flange extending outwards from the outer casing, wherein the flange and the outer casing are formed into a single body having an integral structure.

9. A spray nozzle according to claim 1, wherein second inlet comprises a plurality of second inlet openings opening tangentially around the inner casing at each of the helical sections.

10. A spray nozzle according to claim 1, wherein the spray nozzle is manufactured using an additive manufacturing method.
